(19) United States
(12) Patent Application Publication
(10) Pub. No.: US 2008/0217217 A1
(43) Pub. Date: Sep. 11, 2008

(54) DEVICE AND SYSTEM FOR USE IN IMAGING PARTICULATE MATTER

(75) Inventor: Jerry L. Toms, Washington, NC (US)

Correspondence Address: NIXON PEABODY LLP - PATENT GROUP, 1100 CLINTON SQUARE, ROCHESTER, NY, 14604, US

(73) Assignee: DIGITAL VIDEO WORLD, INC., Liberty, NC (US)

(21) Appl. No.: 11/945,733

(22) Filed: Nov. 27, 2007

Related U.S. Application Data
(62) Division of application No. 09/920,230, filed on Aug. 1, 2001, now abandoned.
(60) Provisional application No. 60/222,379, filed on Aug. 1, 2000.

(51) Int. Cl. B07C 5/10

(52) U.S. Cl. 209/579; 209/659

(57) ABSTRACT

A system for capturing multiple images of an object, the system including: means, in communication with a source of objects, for delivering an object into an image capture zone whereby the object passes through a predetermined point in space within the image capture zone; a first image capture device located a first predetermined distance from the predetermined point in space; and a second image capture device located a first predetermined distance from the predetermined point in space, the second image capture device being substantially 90 degrees offset from the first image capture device.

This application is a divisional application of U.S. patent application Ser. No. 09/920,230, filed Apr. 1, 2001, which claims priority benefit of U.S. Provisional Patent Application Ser. No. 60/222,379, filed Aug. 1, 2000, each of which is hereby incorporated by reference in its entirety.

### FIELD OF THE INVENTION

The present invention relates to a feeder chute device and system for use in the quality control analysis of particulate matter, more particularly, for use in obtaining and/or analyzing a three-dimensional image of particulate matter.

### BACKGROUND OF THE INVENTION

In the manufacturing of particulate materials, it is frequently necessary for quality control purposes to determine, by physical analysis, the quality of small samples. Obviously, even very small deviations from specification can have profound effects on decisions regarding the value or acceptability of the material. Industries which rely on analysis of particulate matter include service aggregate, pharmaceuticals, fertilizer, sugar, soda ash, mining, roofing grit, abrasive grit, etc.

One approach which has been used in the past involves manual separation and examination of a sample by an operator. Manual separation and examination, however, is time consuming and offers a low percentage of sample analysis. Moreover, the analysis is frequently subjective rather than being based on a objective quantitative analysis.

“Time of flight” measurement method requires particles to be propelled through an imaging region by venturi action. Laser scanning on a horizontal plane occurs while the particles descend through the measurement zone on the vertical axis. The measurement is based on the time it takes for each particle to pass through the zone, with samples being taken by the laser based on the frequency of the horizontal oscillation. The time of flight measurement process is hindered by difficulties with the dispersion of particles in a singular vertical column in a venturi, which often results in errors caused by agglomerated particles. Thus, this process requires very small sample sizes and particle sizes to flow in the gas suspension. Moreover, since the time of flight on a single axis is utilized to extrapolate the measurement, it is really only a single axis measurement and, therefore, cannot resolve volume or shape. For these reasons, it is not suitable to replace sieve methods in manufacturing processes.

Laser diffraction measurement methods estimate size of particles by aiming a laser light source at the particles, then when the light is scattered as it hits the particles, a collector array is used to measure angular representation of each scattered beam along with its intensity. This information is reduced to portray the size of the particles. Laser diffraction measurement methods have required very sensitive CCD arrays and calibration of the array at its point in space has proven very difficult. Repeatability has been an issue and some manufactured units must have custom software written specifically for each individual unit to compensate for differences in the collector arrays. It is not suitable for large particles, such as aggregate, as the size of the unit becomes extremely large to permit the alignment of the laser and the proper collection of the scattered light. It is also unsuitable for mounting in industrial areas were vibration occurs due to the problems in alignment.

Line scan image sensors are used in bar coding applications and have been employed in the effort to measure particle size. In two dimensional applications, the line scan camera is aimed at a stream of particles usually dispersed by some sort of standard vibratory feeder tray. The scan frequency determines that best accuracy possible. As particles flow perpendicular to the scanline, the measurement is very sensitive to changes in velocity of the particles through the scanning region. Like other two dimensional analysis, which estimate volume by the projected area, the estimated volume measurements are problematic in that they frequently do not match historical sieve data. This is usually due to anomalies caused by aspect ratios greater than 1:1 or other features which conflict with the sieve method. Another shortcoming of the line scan imaging process is its sensitivity to velocity, which affects the repeatability of measurements.

Yet another automated particle measurement is the automated sieve method, which closely resembles the manual sieve measurement method by creating a stack of sieves in accordance with the ASTM manual method standards. The particulate material is introduced by an automatic feeder and the sieves are moved through vibratory motion for a preset interval (e.g., 15 minutes). Next, each sieve is moved by robot arm with its contents dumped onto a measurement weight scale and a computer captures the weight of the particles collected in each successive sieve. Problems include the high mass vibration requirements which result in excessive noise or physical vibration that are not suitable in a laboratory environment. Moreover, its use online is encumbered by its physical size and need for structure and proximity to its measurement collection scheme. Maintenance costs, both in time and expense, are high due to the moving mass. Results are obtained slowly and are easily contaminated with inadequate automated cleaning of the screens between samples. It is also not suitable for large particles due to the physical size and power limitations. Particle orientation cannot be controlled and therefore results in erroneous measurements, as shape influences significantly whether or not the particles pass through the sieve openings. A related problem is that the sieve method permits elongated or high aspect ratio particles to pass through sieves based on their smallest diameter axis, which does not reflect actual volume of these particles.

The present invention is directed to overcoming these and other deficiencies in the art.

### SUMMARY OF THE INVENTION

A first aspect of the present invention relates to a feeder chute including: a bottom member having a first end which defines a receiving zone and a second end which defines a discharge zone; and a plurality of channels formed in the bottom member within the discharge zone and extending in the direction between the first and second ends, wherein one of the plurality of channels has a terminus defining a first discharge plane and a second channel adjacent to the one channel has a terminus defining a second discharge plane, the second discharge plane being spaced apart from the first discharge plane.

A second aspect of the present invention relates to a feeder chute and a conveyor system in combination, the feeder chute including a bottom member having a first end which defines a receiving zone and a second end which defines a discharge zone, and a plurality of channels formed in the bottom member within the discharge zone and extending in the direction between the first and second ends; and the conveyor system including a plurality of conveyors, each conveyor being aligned beneath one of the plurality of channels of the feeder chute, and each conveyor including a drive wheel operatively coupled to a drive shaft, one or more driven wheels, and a conveyor belt suspended on the drive wheel and the one or more driven wheels, and drive means, coupled to the drive shaft of each conveyor, for driving revolution of each of the plurality of conveyors; wherein one of the conveyors forms a terminus defining a first discharge plane and a second conveyor adjacent to the one conveyor forms a terminus defining a second discharge plane, the second discharge plane being spaced from the first discharge plane.

A third aspect of the present invention relates to a system for capturing multiple images of an object, the system including: means, in communication with a source of objects, for delivering an object into an image capture zone whereby the object passes through a predetermined point in space within the image capture zone; a first image capture device located a first predetermined distance from the predetermined point in space; and a second image capture device located a first predetermined distance from the predetermined point in space, the second image capture device being substantially 90 degrees offset from the first image capture device.

A fourth aspect of the present invention relates to a system for capturing multiple images of an object, the system including: means, in communication with a source of objects, for delivering an object into an image capture zone whereby the object passes through a predetermined point in space within the image capture zone; an image capture device located a predetermined distance from the predetermined point in space; and a mirror positioned within the image capture zone to reflect a reflected image of the object which is substantially 90 degrees offset from a direct image presented to the image capture device; wherein the image capture device captures both the direct image and the reflected image simultaneously.

A fifth aspect of the present invention relates to a method of simultaneously preparing a three-dimensional image of a plurality of objects including: providing a plurality of substantially parallel flows of objects laterally spaced along a first axis; delivering objects from each of the plurality of parallel flows into an image capture zone, whereby the delivering for each flow, relative to each other flow, is spaced apart along a second axis perpendicular to the first axis; and capturing first and second images of each of a plurality of objects passing through the image capture zone, the first and second images being about 90 degrees offset relative to one another.

The present invention offers significant advantages over previously available particulate matter analysis systems, because the present invention provides for automated calculation of three-dimensional particle characteristics using two two-dimensional images of each object rather than a single two-dimensional image thereof. When these two measurements are merged and reduced to a single volume distribution value, this will more closely approximate the sieve measurement method and match historical data sets within the variability defined in the ASTM specifications. These measurements are not only more accurate, they are also repeatable. Moreover, due to its automated nature, it is possible to significantly speed up testing and quality control analysis processes, generate reports which identify whether a test sample of particulate matter matches quality controls specifications. An added benefit of the automated nature of the present invention is that human contact with caustic or toxic particles (e.g., fertilizers) is limited or non-existent. Finally, due to the automated nature of the present invention, high frequency-short interval testing (i.e., during the course of manufacturing) can be carried out to obtain a much higher degree of process control information online, during the manufacturing process. Thus, manufacturing errors can be detected and corrected with minimal loss of manufacturing time and, hopefully, without wasting entire batches of manufactured product.

### BRIEF DESCRIPTION OF THE DRAWINGS

FIG. 1 is an end view of a feeder chute according to one embodiment of the present invention.

FIG. 2 is a top plan view of the feeder chute shown in FIG. 1.

FIG. 3 is an end view of a feeder chute according to a second embodiment of the present invention, with a portion of one V-channel broken away to expose the slot therethrough.

FIG. 4 is a top plan view of the feeder chute according to FIG. 3.

FIG. 5 is a top plan view of a feeder chute in combination with a conveyor system according to another embodiment.

FIG. 6 is a top plan view of another feeder chute in combination with a conveyor system.

FIG. 7 is diagram illustrating one embodiment of a system of the present invention and its integration with a manufacturing process.

FIG. 8 is a schematic diagram illustrating the relationship of components in one embodiment of a system of the present invention.

FIG. 9 is a schematic diagram illustrating the relationship of components in another embodiment of a system of the present invention.

### DETAILED DESCRIPTION OF THE INVENTION

The present invention relates to a feeder chute or the combination of a feeder chute and conveyor system, both of which can be utilized in a system of the present invention which is designed to capture multiple images of one or more objects, allowing for the analysis of physical properties of the object.

As used herein, “object” refers to an individual particle of particulate matter. The invention is applicable to particulate matter of all kinds including, without limitation, crushed stone, aggregate, sands, ores, soda ash, abrasive grits, mineral and metal powders, food particles such as sugar crystals, kernels, oats, seeds and grains, pharmaceuticals in the form of powders and granules, fertilizer granules. Although the feeder chute and the combination feeder chute/conveyor system can be scaled to handle particulate matter of virtually any size, the present invention is preferably capable of operating with particulate matter which is at least about 70 microns in length, more preferably about 100 microns up to about 10 mm in length. The particulate matter can be characterized by aspect ratios of about 1:1 up to about 20:1, more preferably from about 1:1 up to about 10:1. The term “aspect ratio” as used herein refers to the ratio of the longest dimension of the particulate matter to the shortest dimension of the particulate matter. For example, an object having the dimensions 20×5×7 mm would have an aspect ratio of 20:5, or 4:1. An aspect ratio approximate to 1:1 indicates that the particulate matter closely resembles a true sphere.

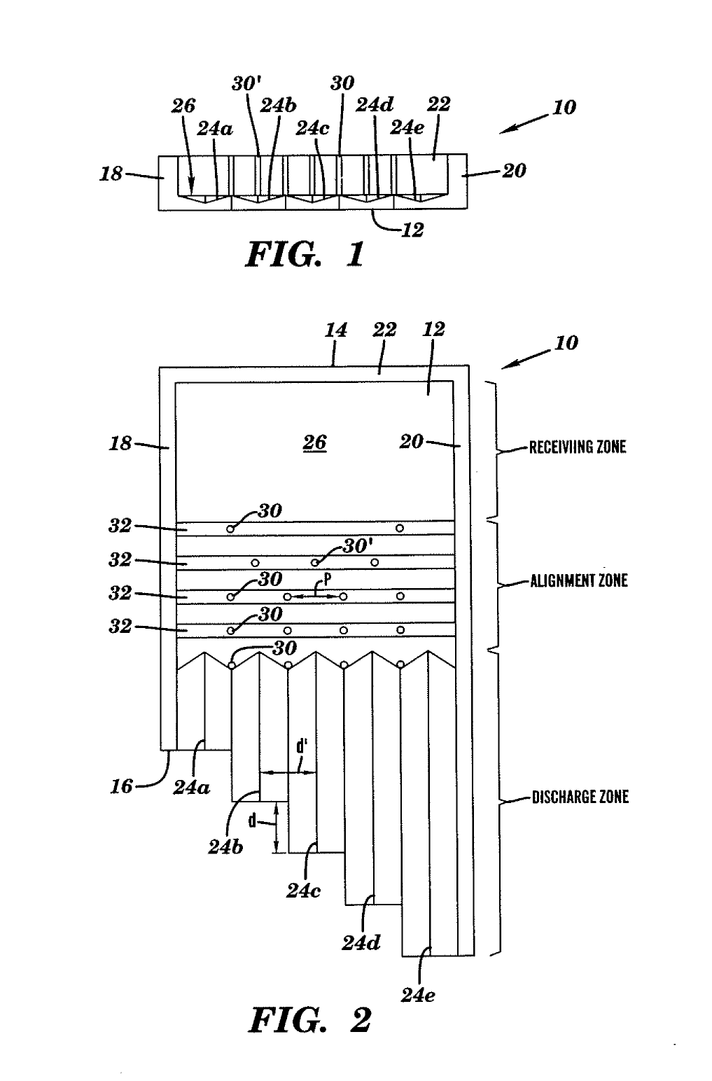

One embodiment of the feeder chute of the present invention is shown in FIGS. 1 and 2. The feeder chute 10 includes a bottom member 12 having a first end 14 which defines a receiving zone and a second end 16 which defines a discharge zone. Along substantially the entire length of each opposite lateral edge of bottom member 12 are upright sidewalls 18, 20; along substantially the entire edge at the first end 14 of the bottom member 12 is a sidewall 22. Sidewalls 18, 20, and 22 can be integrally formed with bottom member 12 or otherwise secured thereto in a manner which inhibits spillage of particulate matter from the feeder chute 10.

The second end 16 of the feeder chute 10 (i.e., within the discharge zone) is characterized by the presence of a plurality of channels 24a-e formed in the otherwise substantially planar upper surface 26 of bottom member 12. The plurality of channels 24a-e extend in the direction between the first and second ends 14, 16. The actual number of channels employed will depend on the volume of particulate matter introduced into the feeder chute and the size of the particulate matter. As shown most clearly in FIG. 1, the channels preferably have a V-shaped cross-section; although, various U-shaped configuration can also be employed. Each of the plurality of channels 24a-e has a terminus (i.e., at the second end) which defines a discharge plane; however, the terminus of no two channels are coincident or lying within the same discharge plane. Thus, as shown most clearly in FIG. 2, containing five distinct channels, the feeder chute 10 has a first channel 24a with a terminus defining a first discharge plane, a second channel 24b adjacent to the first channel with a terminus defining a second discharge plane, a third channel 24c adjacent to the second channel with a terminus defining a third discharge plane, a fourth channel 24d adjacent to the third channel with a terminus defining a fourth discharge plane, and a fifth channel 24e adjacent to the fourth channel with a terminus defining a fifth discharge plane. Each discharge plane is spaced apart from the discharge plane of an adjacent channel.

The plurality of channels 24a-e have the effect of laterally spacing apart, along an first axis, the particulate matter into substantially parallel flows; whereas the separation of the channel termini (and their discharge planes) has the effect of laterally spacing apart the particulate matter along a second axis which is perpendicular to the first axis. It is preferable to achieve maximum two-dimensional spacing of particulate matter by having the distance separating the termini of adjacent channels (d) being substantially the same as the distance separating the trough of adjacent channels (d′).

The bottom member 12 also includes a portion between the first and second ends 14,16 which defines an alignment zone. Within the alignment zone, the feeder chute 10 also includes a plurality of spaced projections 30 extending upwardly from upper surface 26 of bottom member 12. Collectively, the plurality of spaced projections 30 operate to align an object (traveling through the alignment zone) such that its length axis extends substantially in a direction between the first and second ends 14,16 of the bottom member 12.

The plurality of spaced projections 30 are preferably present in the form of at least one linear array, aligned substantially parallel to the channels 24 and defining a passage p between adjacent linear arrays or between a linear array and a sidewall 18, 20. Each passage so defined is co-extensive with a corresponding channel 24. If present, the number of linear arrays of projections is typically one less than the number of channels present.

Depending upon the size characteristics of the particulate matter, it may also be desirable to include a projection 30′ which is spaced apart from the at least one linear array of projections such that it is positioned within a passage defined by adjacent linear arrays or between a linear array and a sidewall 18, 20. As shown in FIG. 2, three such projection 30′ are provided within the passages defined by adjacent linear arrays. Projections 30′, if present, are preferably located centrally of the passage.

While the projections 30, 30′ can have virtually any shape of configuration which facilitates alignment of particulate matter as described above, they preferably have a substantially cylindrical configuration.

The projections 30, 30′ can be permanently or removably attached to the bottom member 12. If permanently attached, the projections 30, 30′ are preferably attached individually to the bottom member at a desired location. When removable attachment is desired, in which case the feeder chute may be adapted for handling a broader range of particulate matter sizes, one or more strips 32 can be removably secured (i.e., mechanically, adhesively, or magnetically) to the bottom member 12 such that the upper surface of each strip 32 is substantially co-planar with upper surface 26. Thus, should replacement of the projections 30, 30′ be desired following excessive wear, an entire strip 32 can be replaced. The projections 30 on strips 32 are appropriately spaced such that upon substitution, the projections 30 can still form the linear array thereof.

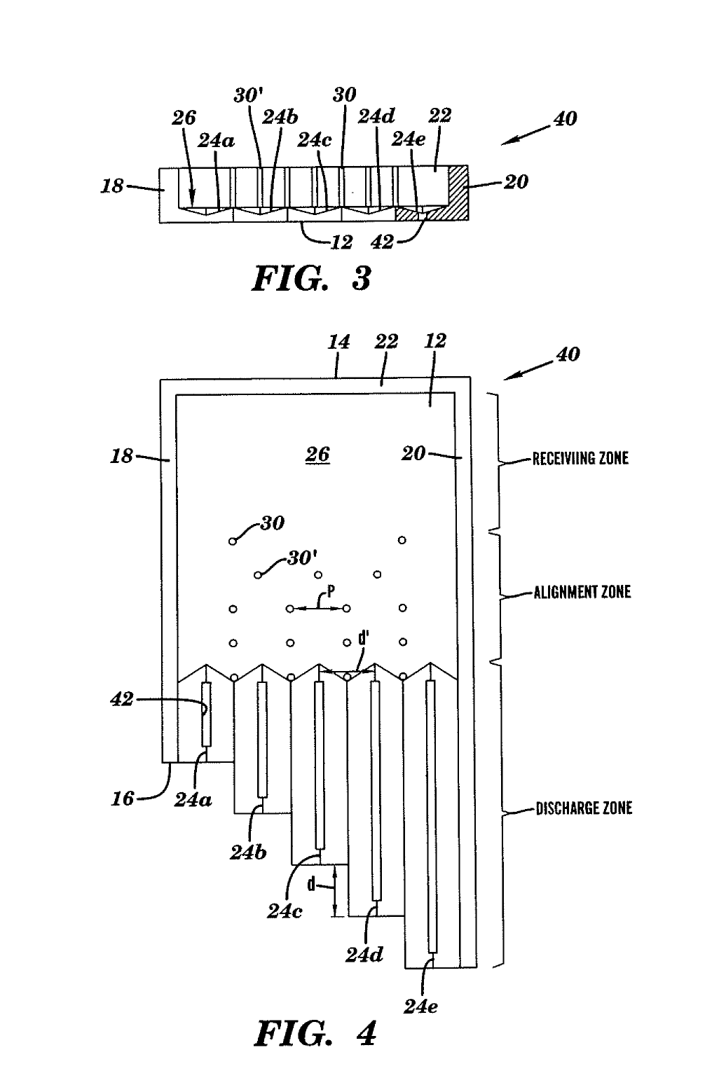

Another embodiment of the feeder chute of the present invention is shown in FIGS. 3 and 4. The feeder chute 40 is similar in overall construction and design to feeder chute 10. One difference is that the projections 30, 30′ are secured to the bottom member 12 individually rather than via strips 32. Although the are secured individually, they can be either permanently or removably secured. A second difference is that each channel 24 includes a slot 42 formed therein. Slot 42 allows for particulate matter which is below a threshold smallest dimension to pass therethrough, while only particulate matter above the threshold actually travels to the terminus of channel 24. As shown, the slot 42 preferably does not extend the entire length of channel 24.

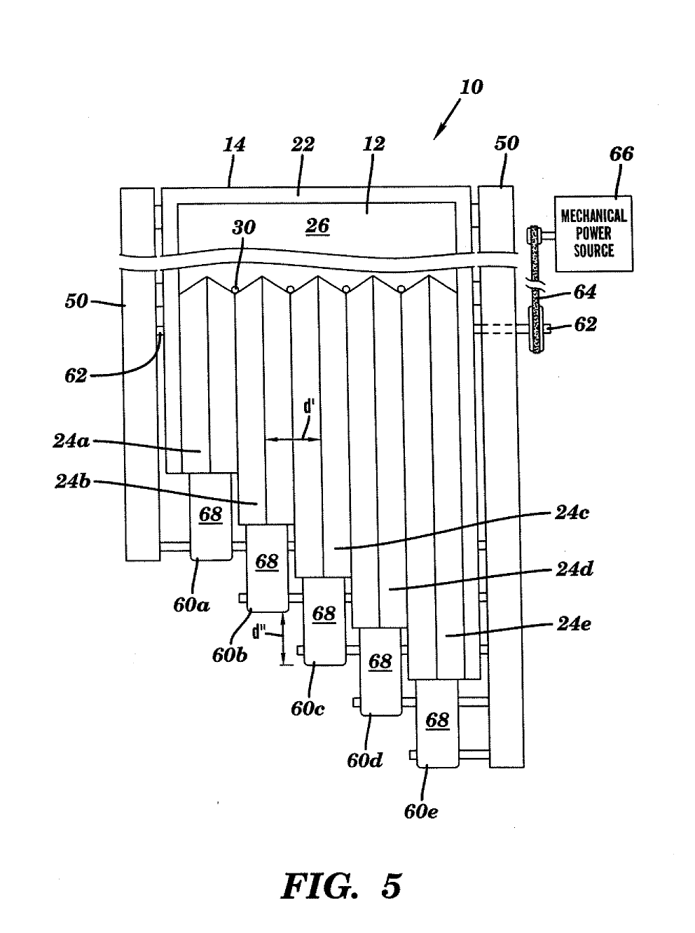

Either feeder chute 10, 40 can also used in combination with a conveyor system. As shown in FIG. 5, a feeder chute 10 and a conveyor system are supported on a frame 50. The conveyor system includes a plurality of conveyors 60, the number of conveyors being the same as the number of channels 24, whereby each conveyor 60 is associated with (i.e., positioned beneath) a single channel 24 to receive particulate matter therefrom. When utilized, conveyor systems offer the ability to control the velocity of objects before the free-fall into an image capture zone (discussed hereinafter).

Each conveyor 60 includes a drive wheel operatively coupled to a drive shaft 62, which is coupled by a belt 64 to a mechanical power source 66, such as an electrical engine. The drive wheel of each conveyor 60 is preferably the same (i.e., has the same circumference), allowing each conveyor to travel at the same linear velocity. Along the length of each conveyor are driven wheels, which are supported on shafts and facilitate conveyor travel. Suspended on the drive wheel and driven wheels is a conveyor belt 68, which can be formed of any material for carrying particulate matter. Thus, belt 68 can be formed of a continuous web of material or, if belt weight is to be minimized, the belt 68 can be formed of a perforated material whose perforations are small enough to prevent the particulate matter from passing therethrough.

Each conveyor, like each channel, is characterized by a terminus (i.e., displaced from the second end of the bottom member 12) which defines a discharge plane; however, the terminus of no two conveyors are coincident or lying within the same discharge plane. Thus, as shown most clearly in FIG. 5, illustrating a feeder chute with five distinct channels and a conveyor system with a corresponding five distinct conveyors, the conveyor system includes a first conveyor 60a associated with channel 24a and having a terminus defining a first discharge plane, a second conveyor 60b associated with channel 24b and having a terminus defining a second discharge plane, a third conveyor 60c associated with channel 24c and having a terminus defining a third discharge plane, a fourth conveyor 60d associated with channel 24d and having a terminus defining a fourth discharge plane, and a fifth conveyor 60e associated with channel 24e and having a terminus defining a fifth discharge plane. Each conveyor discharge plane is spaced apart from the discharge plane of an adjacent conveyor.

As noted above for feeder chute 10, the plurality of channels 24a-e have the effect of laterally spacing apart, along a first axis, the particulate matter into substantially parallel flows; whereas the separation of the conveyor termini (and their discharge planes) has the effect of laterally spacing apart the particulate matter along a second axis which is perpendicular to the first axis. As before, it is preferable to achieve maximum two-dimensional spacing of particulate matter by having the distance separating the termini of adjacent conveyors (d″) being substantially the same as the distance separating the trough of adjacent channels (d′).

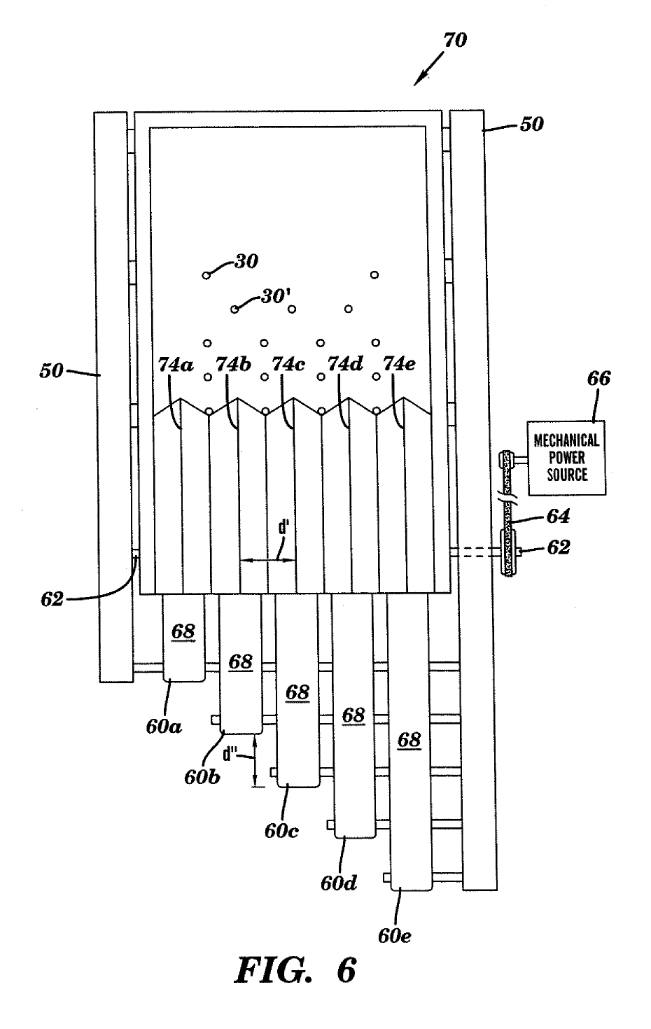

When a conveyor system is utilized, any feeder chute of the present invention can be utilized therewith. An alternative embodiment of the feeder chute can also be employed, as shown in FIG. 6, which illustrates a feeder chute 70 and a conveyor system supported on a frame 50.

The feeder chute 70 is similar in overall construction and design to feeder chute 10. One difference is that the projections 30, 30′ are secured to the bottom member 12 individually rather than via strips 32. Although they are secured individually, they can be either permanently or removably secured. A second difference is that each channel 74 terminates in a common discharge plane.

The conveyor system includes a plurality of conveyors 60, the number of conveyors being the same as the number of channels 74, whereby each conveyor 60 is associated with (i.e., positioned beneath) a single channel 74 to receive particulate matter therefrom. The conveyor system is substantially the same as the conveyor system described in connection with FIG. 5. Each conveyor is characterized by a terminus (i.e., displaced from the second end of the bottom member 12) which defines a discharge plane; however, the terminus of no two conveyors are coincident or lying within the same discharge plane. Thus, as shown most clearly in FIG. 6, illustrating a feeder chute with five distinct channels and a conveyor system with a corresponding five distinct conveyors, the conveyor system includes a first conveyor 60a associated with channel 74a and having a terminus defining a first discharge plane, a second conveyor 60b associated with channel 74b and having a terminus defining a second discharge plane, a third conveyor 60c associated with channel 74c and having a terminus defining a third discharge plane, a fourth conveyor 60d associated with channel 74d and having a terminus defining a fourth discharge plane, and a fifth conveyor 60e associated with channel 74e and having a terminus defining a fifth discharge plane. Each conveyor discharge plane is spaced apart from the discharge plane of an adjacent conveyor.

The plurality of channels 74a-e have the effect of laterally spacing apart, along a first axis, the particulate matter into substantially parallel flows; whereas the separation of the conveyor termini (and their discharge planes) has the effect of laterally spacing apart the particulate matter along a second axis which is perpendicular to the first axis. As before, it is preferable to achieve maximum two-dimensional spacing of particulate matter by having the distance separating the termini of adjacent conveyors (d″) being substantially the same as the distance separating the trough of adjacent channels (d′).

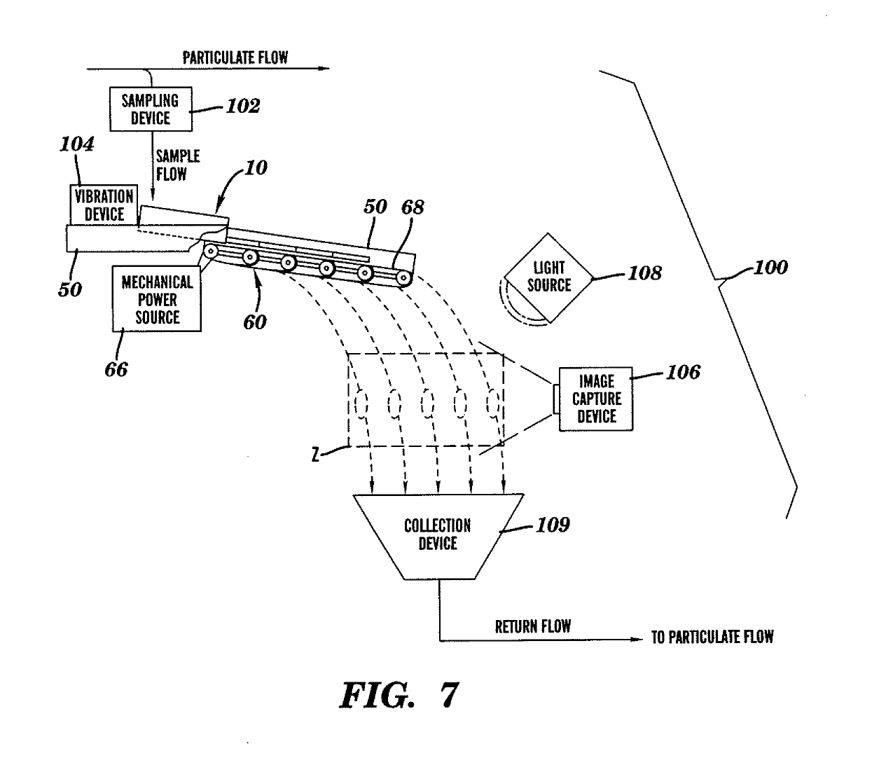

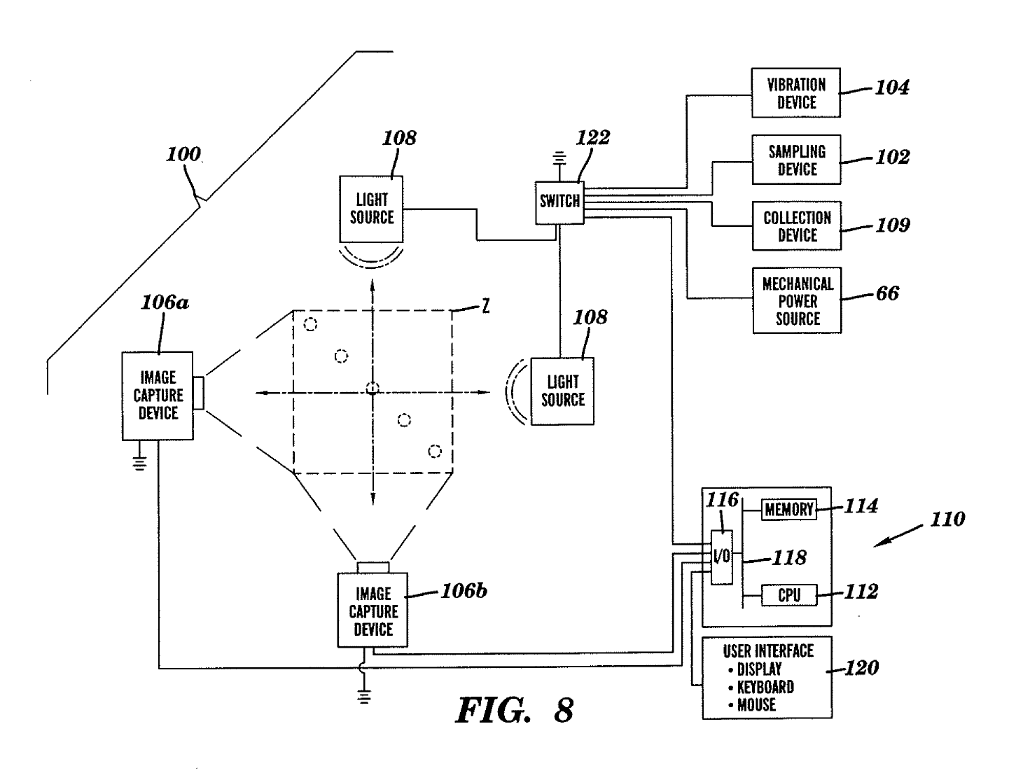

The various feeder chutes or combination feeder chute/conveyor systems are intended to be used in a system for capturing multiple images of an object. One embodiment of such a system 100 is illustrated in FIGS. 7 and 8.

A sampling device 102 is provided for diverting or otherwise collecting a sample from a flow of particulate matter. The sampling device 102 can be of any conventional design. As can be appreciated by one of ordinary skill in the art, sampling devices will vary from industry to industry. The sampling device 102 need only be capable of collecting the sample from the flow of particulate matter and then communicate the sample flow into the receiving zone of a feeder chute of the present invention (or combination feeder chute/conveyor system of the present invention).

As shown in the embodiment of FIG. 7, the feeder chute 10 is provided in combination with conveyor system 60 as described above. To assist in the continued flow of particulate matter from the receiving zone toward the discharge zone of the feeder chute 10, the feeder chute is positioned on frame 50 so that the upper surface of bottom member 12 is sloped and a vibration device 104 is coupled to the feeder chute. The vibration device can be any conventional type of vibration device which is known in the art including, without limitation piezo-type high frequency vibration devices and a cam-driven rocker arm vibration devices.

It should be appreciated by those of ordinary skill in the art that any means can be provided for laterally spacing apart, along a first axis, the particulate matter into substantially parallel flows; and for laterally spacing apart the particulate matter along a second axis which is perpendicular to the first axis. The net effect of this process is that a plurality of object can be delivered simultaneously into an image capture zone z, whereby each object passes through a predetermined point in space within the image capture zone, which point is a predetermined distance from one or more image capture devices 106.

As shown in FIG. 8, two image capture devices are provided in one embodiment of the system. The first image capture device 106a is positioned relative to the feeder chute 10 (and conveyor system 60) to be capable of capturing a first image of an object passing through the image capture zone z. The second image capture device 106b is positioned relative to the feeder chute 10 (and conveyor system 60) to be capable of capturing a first image of an object passing through the image capture zone z. The second image capture device 106b is preferably positioned substantially 90 degrees offset from the first image capture device 106a. Suitable image capture devices include, without limitation, cameras, digital cameras, digital video cameras, line scan cameras, ccd arrays, and smart cameras with integral digital signal processors for pre-processing outside a central processor unit.

One advantage of a digital camera array is that the higher resolution arrays make it possible to accurately measure a wider range of materials as it relates to size. For example, a standard video camera with a horizontal pixel count of 750 can be increased to up to 2048 pixels horizontal or more with commercially available digital array cameras. If the feed chute width is about 200 millimeters, the standard video camera will only resolve to 3.75 pixels per millimeter which means that the smallest particle that could be measured with accurate repeatability would be about 1 mm. By incorporating the digital image sensor or digital video high resolution array at 2048 pixels, the same feeder chute and system can resolve to measure particles as small as 300 microns. The use of smaller feed chutes, which allow the image capture devices to be even closer to the particulate matter as it passes through the image capture zone allow for resolution of even smaller particles. Moreover, due to the flexibility of the system and the range of particle sizes which can be accommodates, a single system of the present invention can be utilized to accommodate quality control analysis of different particulate materials.

Optionally, a third image capture device can be employed from above the free-falling objects which pass through the image capture zone. As another option, four image capture devices can be employed, with the third and fourth image capture device being positioned substantially about 90 degrees offset from one another and substantially about 45 degrees offset from the first and second image capture devices.

To facilitate the capturing of images of particulate matter passing through the image capture zone, the image capture zone is illuminated by one or more light sources 108. Exact positioning of the light sources can be optimized by one of ordinary skill in the art to provide the clearest image of objects passing through the image capture zone, either by backlighting (i.e., with the object between the light source and image capture device), lighting from above or below, or lighting from behind the image capture devices (i.e., with the image capture device between the object and the light source), or combinations thereof. Suitable light sources include, without limitation, a strobe light, a short wavelength strobed LED, a continuous fluorescence high frequency light, and combinations thereof.

When measuring large particles, such as aggregate for highway construction, use of large hi-frequency fluorescent backlight is preferred due to its cost-effectiveness.

When measuring small particles where light is more easily controlled, the strobed LED is typically more effective, because the strobe effect aids in separating the particle edges as it relates to resolving the image for measurement. This is particularly true when utilizes slower scan rate image capture cameras. Shuttered cameras can also be used with significant light to produce the same frozen image effect at the moment of capture

Where backlighting is utilized, it is desirable to also utilize a flat screen, which allows the image capture device to measure a shadow projected onto the screen that is located at a constant distance from the lens and focal plane. As discussed hereinafter, the captured image is standardized based upon a constant or magnification factor which corrects for the distances between each object and the light source and the screen.

Alternatively, the image of the object (rather than its shadow) can be captured directly by the image capture device. As discussed hereinafter, the captured images are standardizes based upon a constant or magnification factor which corrects for the distance between the image capture device and the focal plane of each object.

After the objects pass through the image capture zone, the objects are collected in a collection device 109, which creates a return flow of particulate matter to direct it back to the particulate flow from which the sample flow was diverted. Alternatively, the return flow can be directed elsewhere for further analysis, e.g., chemical analysis, if so desired.

Images captures by the image capture devices 106a, 106b are transferred to a computer 110 in communication therewith. The computer 110 includes a central processing unit (“CPU”) 112, memory 114 and I/O unit 116, which are coupled together by a bus 118. A user interface 120 includes a collection of components which an operator may employ in the use of the computer 110, including, without limitation, a video display unit, keyboard, mouse, etc. The computer 110 can be any one of several designs, including PC, Mac, or Unix-based; it can also be present in a stand-alone format or provided within a network of various sizes. The CPU 112 may include a processor. The CPU 112 executes at least one program of stored instructions for processing the images of objects in accordance with the present invention as described and illustrated herein. The CPU 112 may also execute instructions for other tasks, including network services, for providing data, memory, file directories, individual files, word processing applications, accounting applications or engineering applications, etc. The instructions may be expressed as executable programs written in a number of computer programming languages, such as BASIC, Pascal, C, C++, C#, Java, Perl, COBOL, FORTRAN, assembly language, machine code language, or any computer code or language that can be understood and performed by the CPU 112. Memory 114 can include any type of memory device accessible by the CPU 112, such as hard-disks, floppy-disks, compact disks (“CD”), digital video disks (“DVD”), magnetic tape, optical disk, ferroelectric memory, read only memory (“ROM”), random access memory (“RAM”), electrically erasable programmable read only memory (“EEPROM”), flash memory, erasable programmable read only memory (“EPROM”), static random access memory (“SRAM”), dynamic random access memory (“DRAM”), ferromagnetic memory, charge coupled devices, smart cards, or any other type of computer-readable mediums. One or more sets of universal interfaces or data objects may be stored in memory 114 so they can be retrieved as needed by the CPU 112 during operation of the present invention as will be described in further detail herein. Further, memory 114 can store one or more software programs, addressed hereinafter, which can digitally analyze particulate matter for particle characteristics including, without limitation, several size measurements, shape measurements, surface characteristics, color, angularity, elongation, flatness, aspect ratio, circularity, sphericity, etc., the steps of which are carried out by CPU 112 as described above.

Computer 110 can communicate with the image capture devices 106a, 106b using I/O unit 116. Computer 110 can also control operation of the sampling device 102, vibration device 104, light sources 108, collection device 109, and mechanical power source 66 via one or more digital switches 122 that control electrical power supply to those devices. The I/O unit 116 can include a router or any other device which has a sufficient number of ports to operatively couple computer 110 to the user interface components 120 and digital switches 122, or otherwise directly to the sampling device 102, vibration device 104, light sources 108, collection device 109, and mechanical power source 66, if so desired.

A number of suitable software programs are available commercially for digitally analyzing particulate matter for particle characteristics. These include, without limitation, DT Vision Foundry (available from Data Translation, providing contour classifier, blob analysis, arithmetic, morphology, shape measurements, etc.) and various programs available from eVision, such as EasyImage, EasyMeasure (point location), EasyObject (area analysis, gravity center analysis, gray scale centroid analysis, ellipse of inertia analysis, etc.), EasyMatch (matching 128×128 pattern, with ability to compensate for 15 degree +/− rotation), and EasyColor (pixel variance and other routines).

Other software sets are provided as dedicated libraries supporting chip sets on various brands of image capture boards. Thus, many types of imaging systems, when installed into a system of the present invention, include software required for calculation of two-dimensional particle properties.

Raw data obtained from the two-dimensional measurements are stored in a suitable database, located either on the computer 110 or on another storage device present on a network. The raw data obtained from the two dimensional measurements are then processed in the manner described below.

For each two-dimensional measurement performed by the commercially available software programs, the values are converted by a constant or multiplier. The multiplier is based on the predetermined distance from the image capture device to the predetermined point in space through which objects pass. Thus, the farther the predetermined point in space is from an image capture device, the higher the multiplier. Each stream of particulate matter passing through the image capture zone is associated with a distinct predetermined point in space (i.e., each channel of the feeder chute corresponds to a single predetermined point in space). Because two image capture devices are present, each predetermined point in space is associated with a first multiplier specific for images captured by the first image capture device and a second multiplier specific for images captured by the second image capture device. Thus, the two-dimensional image calculations carried out by the commercially available software programs are standardized by adjusting values for two-dimensional image analysis to account for the distance of the focal plane from the image capture device. Because the distances between each focal plane and each of the two image capture devices remain constant, calibration is required only once.

The same principle applies to measurements taken using the backlighted approach described above, where the shadow cast by an object is measured at a fixed distance from the image capture device.

Having standardized the size measurements of objects based upon their location within the image capture zone relative to the image capture device (or screen), other characteristics of the objects can be more accurately calculated, including projected surface area on two planes, equivalent spherical diameter from two planar views, elongation, flatness, coarse and fine aggregate angularity, circularity, sphericity, aspect ratios, volume calculations, parasitic nodules of malformed particles or particles adhering to base particle.

With respect to aspect ratios, the two images are more capable of defining the smallest width of the object. When using only a single two-dimensional image, the particle aspect ratio is often over-assessed (unless the smallest dimension is presented). The second view provided by the second image capture device increases the aspect ratio accuracy by detecting the smallest aspect of the object not otherwise detected by the single view.

When the measurements from the first and second image capture devices are merged (i.e., after standardization with the multiplier) using commonly available mathematical algorithms for merging the raw two-dimensional data into three dimensional data. The pre-written code can be assembled line-by-line to convert the various two-dimensional data into three-dimensional data. The code is available in various formats such as C++.

Each image is analyzed where the shadow (dark) pixels are isolated and counted for a two dimensional area measurement. A second analysis is done based on known axis measurements where a long and short axis are identified by the number of dark pixels along each respective axis. Next, an area calculation is performed based on these two measured axis and volume estimates are normally calculated. The results of these calculations are compared between the two planar images. Next, the vertical axis dimension and the horizontal axis dimension from image one are multiplied by each other and then by the horizontal axis of the second image. This volume information is compared to the pixel count volume calculations made from the two images in the first iteration to resolve the best estimate of the particle volume. When the goal is to match historical sieve data in manufacturing processes, the algorithm is designed to mimic the errors to the sieve which are inherent in the design of the mechanical sieve and the ASTM method.

Once the initial size and volume calculations are completed, or simultaneously as it relates to multitasking operations of the CPU environment, separate calculations are accomplished to identify the following:

Elongation=aspect ratio from the frontal image projection with camera device pointed directly at the front end of the feeder chute mechanism

Flatness=aspect ratio from the second image projection taken with the camera device shooting at the particle stream from the side at 90 degrees or perpendicular to the first camera capture device.

Angularity=where two mathematical representations are analyzed. The first is a measurement of the curvature of the perimeter of the particle compared to a circle. The second identifies abrupt changes in the linearity of pixels identifying the boundary of the perimeter of the particle. These changes are in the form of an angular difference across a number of pixels to represent steep departures from the curve—thus more angular. A separate classification mathematical model can be used to separate the angularity measurements by particle size.

An irregular particle model includes a template match comparison which is more easily described as teaching the software a “regular particle shape” and then performing a template match based on that shape to identify particles which would be considered irregular. In some crystallization processes, these are used to detect small particles which have attached themselves to more well formed crystals (i.e., parasites).

Classification modeling can also be accomplished by separating the results by parameters selectable by the end user of the software. Classification can be based on particle size distribution based on: equivalent spherical diameter, sieve equivalent diameter, aspect ratio distribution, elongation distribution, flatness distribution, course aggregate angularity distribution, fine aggregate angularity distribution, irregular particle distribution or count (i.e., the number of particles whose template match results in abnormal shape characteristics when compared to the regular model, circular or otherwise), particle mean size and standard deviation for each representative measured sample.

Separate graphics software operated off-line can then be utilized to import and sort the database data for a variety of process monitoring purposes and to create easier to view graphical representations of the data which differ in the variety of industry applications. Separate spreadsheet or word processing software can be utilized to import data and generate reports which the operator deems significant for immediate process control. With network access, a home office can compare online results from multiple regional or global manufacturing sites to insure more accurate process control on a global basis and identify immediately any abnormal plant operations parameters.

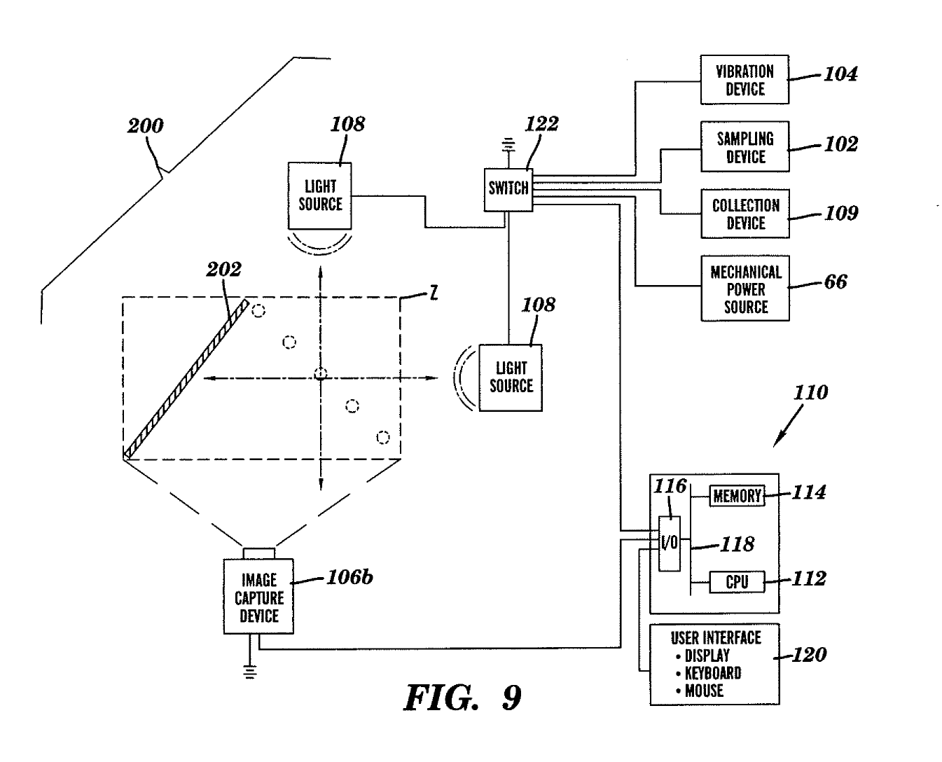

Yet another embodiment of the system is illustrated in FIG. 9. The system 200 utilizes all of the same components of system 100 illustrated in FIGS. 7 and 8, except that one of the image capture devices 106 is replaced by a mirror 202 positioned within the image capture zone z. The mirror 202 shown in FIG. 9 is positioned such that the mirror image of the objects is also captured by the single image capture device 106. Thus, the single image capture device captures two images of each object in the image capture zone, the images being substantially perpendicular views of the various objects. To resolve the images, multipliers are again associated with each image position, although the mirror image which is captured must be inverted during data analysis. Otherwise, data calculations proceed as described above. Although only one mirror is shown, it should be appreciated by those of skill in the art that additional images can also be utilized.

Regardless of the embodiment, use of the system of the present invention involves obtaining a sample of particulate matter and delivering it to a feeder chute of the present invention. The vibration device causes the particulate matter to flow from the receiving zone toward the discharge zone on the inclined bottom surface of the feeder chute. If present, the alignment zone will assist in dispersing the flow and orienting the particulate matter with it long axis parallel to the channels. The particulate matter will then proceed through the channels toward the discharge end, where they will fall onto the surface of the conveyers, if present, and subsequently through the image capture zone. The conveyors, when present, will apply a uniform velocity to each object prior to its free fall into the image capture zone. As objects pass through the image capture zone, the various two dimensional images are captured and the raw data on each particle is calculated by standard image analysis software. The raw data is modified using a multiplier to convert for is position within the image capture zone (i.e., standardizing the pixel counts) and data analysis from the two or more two-dimensional images is merged to provide three-dimensional data for each of the objects.

Thus, another aspect of the present invention relates to a method of simultaneously preparing a three-dimensional image of a plurality of objects. This method includes the steps of providing a plurality of substantially parallel flows of objects laterally spaced along a first axis, delivering objects from each of the plurality of parallel flows into an image capture zone, whereby the delivering for each flow, relative to each other flow, is spaced apart along a second axis perpendicular to the first axis, and then capturing first and second images of each of a plurality of objects passing through the image capture zone, the first and second images being about 90 degrees offset relative to one another.

As noted above, the providing of a plurality of substantially parallel flows of objects laterally spaced along a first axis can be carried out as described above using a feeder chute of the present invention or a combination of a feeder chute and conveyor system of the present invention, both of which disperse a single flow of particulate matter into a plurality of substantially parallel flows.

The delivering of the objects into the image capture zone can be carried out as described above using a feeder chute of the present invention or a combination of a feeder chute and conveyor system of the present invention, both of which will deliver each flow to a distinct predetermined point within the image capture zone such that each flow, relative to each other flow, is spaced apart along a second axis perpendicular to the first axis.

In a preferred embodiment, the capturing of first and second images is carried out simultaneously. As noted above, in processing the captured images, initial size calculations are adjusted using a constant multiplier or magnification factor.

Other embodiments of the present invention can be developed by combining two or more systems of the present invention. For example, where a relatively large range of particle sizes is being prepared and subsequently analyzed using a system of the present invention, it may be desirable to utilize feeder chute 40 for the purpose of removing fine particulate matter from coarse particulate matter. Fine particulate matter passing through slot 42 would be directed to an independent feeder chute 10 (either alone or in combination with a conveyor system 60), allowing both fine and coarse particulate matter to be separate analyzed using separate systems for image capture, as described above.

Because the present invention is intended to be operated in conjunction with a continuous manufacturing process (for producing particulate matter), the control system described above can also be provided with an alarm, whereby any deviation of a particular measurement outside of a predetermined range (or a combination of several measurements outside of the respective, predetermined range) will cause the computer 110 to execute an alarm signal to notify an operator of the deviation. The operator can shut-down manufacturing processes as necessary, or modify manufacturing processes to ensure that the product meets the requisite specifications.

Alternatively or in addition to sounding an alarm, the computer 110 can be networked with computerized control mechanisms for the grinding or crushing devices (of the manufacturing process), allowing the computer 110 to provide feedback for the fine-tuning of grinding and/or crushing operations.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A system for capturing multiple images of an object, the system comprising:
a delivery device, in communication with a source of objects, that delivers an object into an image capture zone whereby the object passes through a predetermined point in space within the image capture zone;
a first image capture device located a first predetermined distance from the predetermined point in space; and
a second image capture device located a first predetermined distance from the predetermined point in space, the second image capture device being substantially 90 degrees offset from the first image capture device.

2. The system according to claim 1, wherein the delivery device comprises a feeder chute comprising:
a bottom member having a first end which defines a receiving zone and a second end which defines a discharge zone;
a plurality of channels formed in the bottom member within the discharge zone and extending in the direction between the first and second ends, wherein one of the plurality of channels has a terminus defining a first discharge plane and a second channel adjacent to the one channel has a terminus defining a second discharge plane, the second discharge plane being spaced apart from the first discharge plane.

3. The system according to claim 1, wherein the delivery device comprises a feeder chute in combination with a conveyor system, the feeder chute comprising:
a bottom member having a first end which defines a receiving zone and a second end which defines a discharge zone, and
a plurality of channels formed in said bottom member within the discharge zone and extending in the direction between the first and second ends; and
the conveyor system comprising:
a plurality of conveyors, each conveyor being aligned beneath one of the plurality of channels of the feeder chute, and each conveyor including a drive wheel operatively coupled to a drive shaft, one or more driven wheels, and a conveyor belt suspended on the drive wheel and the one or more driven wheels, and
drive means, coupled to the drive shaft of each conveyor, for driving revolution of each of the plurality of conveyors;
wherein one of said conveyors forms a terminus defining a first discharge plane and a second conveyor adjacent to said one conveyor forms a terminus defining a second discharge plane, the second discharge plane being spaced from said first discharge plane.

4. The system according to claim 1 further comprising one or more light sources which illuminate the image capture zone.

5. The system according to claim 4, wherein the one or more light sources are selected from the group consisting of a strobe light, a strobed LED, a continuous fluorescence high frequency light, and combinations thereof.

6. The system according to claim 1 further comprising:
a processor in communication with said first and second image capture devices.

7. A system for capturing multiple images of an object, the system comprising:
a delivery device, in communication with a source of objects, that delivers an object into an image capture zone whereby the object passes through a predetermined point in space within the image capture zone;
an image capture device located a predetermined distance from the predetermined point in space; and
a mirror positioned within the image capture zone to reflect a reflected image of the object which is substantially 90 degrees offset from a direct image presented to the image capture device;
wherein the image capture device captures both the direct image and the reflected image simultaneously.

8. The system according to claim 7, wherein the delivery device is a feeder chute comprising:
a bottom member having a first end which defines a receiving zone and a second end which defines a discharge zone;
a plurality of channels formed in the bottom member within the discharge zone and extending in the direction between the first and second ends, wherein one of the plurality of channels has a terminus defining a first discharge plane and a second channel adjacent to the one channel has a terminus defining a second discharge plane, the second discharge plane being spaced apart from the first discharge plane.

9. The system according to claim 7, wherein the delivery device comprises a feeder chute in combination with a conveyor system, the feeder chute comprising:
a bottom member having a first end which defines a receiving zone and a second end which defines a discharge zone, and
a plurality of channels formed in said bottom member within the discharge zone and extending in the direction between the first and second ends; and
the conveyor system comprising:
a plurality of conveyors, each conveyor being aligned beneath one of the plurality of channels of the feeder chute, and each conveyor including a drive wheel operatively coupled to a drive shaft, one or more driven wheels, and a conveyor belt suspended on the drive wheel and the one or more driven wheels, and
drive means, coupled to the drive shaft of each conveyor, for driving revolution of each of the plurality of conveyors;
wherein one of said conveyors forms a terminus defining a first discharge plane and a second conveyor adjacent to said one conveyor forms a terminus defining a second discharge plane, the second discharge plane being spaced from said first discharge plane.

10. The system according to claim 7 further comprising one or more light sources which illuminate the image capture zone.

11. The system according to claim 10, wherein the one or more light sources are selected from the group consisting of a strobe light, a strobed LED, a continuous fluorescence high frequency light, and combinations thereof.

12. The system according to claim 7 further comprising a processor in communication with said image capture device.

13. A method of simultaneously preparing a three-dimensional image of a plurality of objects comprising:
providing a plurality of substantially parallel flows of objects laterally spaced along a first axis;
delivering objects from each of the plurality of parallel flows into an image capture zone, whereby the delivering for each flow, relative to each other flow, is spaced apart along a second axis perpendicular to the first axis;
capturing first and second images of each of a plurality of objects passing through the image capture zone, the first and second images being about 90 degrees offset relative to one another.

14. The method according to claim 13, wherein said providing a plurality of laterally spaced, substantially parallel flows comprises:
providing a flow of objects and
dispersing the flow into the plurality of substantially parallel flows

15. The method according to claim 13, wherein said capturing first and second images is carried out simultaneously.

16. The method according to claim 13, wherein each of the plurality of substantially parallel flows passes through a predetermined point within the image capture zone and each predetermined point is assigned a predetermined magnification factor, the method further comprising:
adjusting the size of the first and second images for each of the plurality of objects by multiplying the size thereof by the predetermined magnification factor.
